(19) United States
(12) Patent Application Publication
(10) Pub. No.: US 2006/0232613 A1
(43) Pub. Date: Oct. 19, 2006

(54) Video-signal processing apparatus and video display system

(75) Inventors: Atsushi Matsuno, Tokyo (JP); Nobuhiko Saegusa, Yamanashi-ken (JP); Tetsuya Shigeta, Yamanashi-ken (JP); Hiroshi Ando, Tokyo (JP); Hirofumi Honda, Yamanashi-ken (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/392,943

(22) Filed: Mar. 30, 2006

(30) Foreign Application Priority Data
Mar. 31, 2005 (JP) 2005-104218

(51) Int. Cl. G09G 5/10

(52) U.S. Cl. 345/690

(57) ABSTRACT

In an apparatus for processing video signals to control a display device that displays a video, a display video signal is generated for each of the colors from received video signals; a delayed display video signal is generated for each display video signal by delaying the display video signal by one field; an afterglow level of at least a first color among the colors is calculated based on the delayed display video signals; a correction signal is generated based on the afterglow level; a display video signal for the first color is selected as the display video signal of the first color when a level of the display video signal of the first color is equal to or higher than the correction signal, and the correction signal is selected when a level of the display video signal of the first color is lower than the correction signal.

### BACKGROUND OF THE INVENTION

1. Field of the Invention

The present invention relates to a video-signal processing apparatus and a video display system.

2. Description of the Related Art

In recent years, plasma display panel (hereinafter, PDP) display devices are rapidly becoming popular, as they are thin, large-screen, and high-quality. PDPs utilize the fact that when current is applied to noble glass the noble gas emits ultraviolet light, and when the ultraviolet light falls on phosphors the phosphors emit a visible light (light emission). In a PDP, cells including phosphors of three primary light colors, which are red (hereinafter, R), green (hereinafter, G), and blue (hereinafter, B), are arranged in a matrix, and a video is displayed by emitting light from the phosphors of R, G, B in each cell.

The phosphors are binary light-emitting elements, and therefore, brightness of luminous colors of the phosphors is adjusted with a gradation display for controlling integral luminous quantity in units of one field by luminous pulses. However, even if a luminous pulse is turned off, luminous quantity does not attenuate immediately when the luminous pulse falls, so that an afterglow of the luminous color occurs.

Because different materials are used for the phosphors of R, G, B, it is obvious that afterglow characteristics differ for each color. For example, as shown in FIG. 1, although the same luminous pulse P is applied to the phosphors of R, G, B, attenuation characteristics differ for each phosphors. The difference is particularly large for the afterglows of the phosphors of R and G in view of the afterglow of the phosphor of B.

Such a difference in afterglow causes the PDP to display a color that is not the intended color. A color displayed by a PDP is an additive mixture of the luminous colors of the phosphors of R, G, B. Therefore, if any of the luminous colors is missing, the resultant color is affected. For example, in a moving image of a comet, a white comet moves in a black background of the night sky. White is an additive color obtained by adding R, G, B. Due to the principle of additive color mixing, a yellow tail is created from R and G, which trails from the white main body of the comet. The yellow tail gives an incongruous impression to a viewer.

Japanese Patent Application Laid Open No. 2002-14647 and Japanese Patent Application Laid Open No. 2004-138940 disclose conventional technologies to solve this problem. Japanese Patent Application Laid Open No. 2002-14647 discloses a technology for reducing the incongruity caused by the tail. Specifically, pixel values (brightness) of each cell in a previous field are uniformly reduced for each luminous color, and the resultant values are overlapped on pixel values of luminous colors of each cell in a current field, thus alleviating an affect of afterglows from the previous field.

Japanese Patent Application Laid Open No. 2004-138940 discloses a technology for eliminating the incongruity. Specifically, each field includes a plurality of subfields that have different brightness weights, and a color image display device controls light emission of each subfield, so as to display multiple gradation levels. An image signal of a previous field is separated into subfield signals, and the subfield signal that has the largest brightness weight is multiplied by an afterglow coefficient to obtain a pseudo afterglow signal. The pseudo afterglow signal is added to a video signal of a current field to make an afterglow of the previous field have the same color as a current image.

However, in the conventional technology disclosed in Japanese Patent Application Laid Open No. 2002-14647, image signals of a previous field are uniformly reduced, and the resultant values are overlapped on image signals of a current field. Therefore, sometimes a video signal to be overlapped becomes too large and sometimes it becomes too small. As a result, sometimes the tail of the comet is not displayed at all, whish increases the incongruity.

In the conventional technology disclosed in Japanese Patent Application Laid Open No. 2004-138940, different afterglow coefficients are used for each subfield. Therefore, the technology is effective when one field includes a plurality of subfields having different brightness weights, and a light emission control method is employed to control light emission of each subfield. Specifically, a random light emission method is employed for expressing brightness with combinations of luminous pulses in each subfield. However, it is difficult to apply the technology to another light emission control method, for example, a frontward light emission method, by which one field is divided into a number of subfields corresponding to the number of gradation levels, luminous pulses are sequentially generated starting from the forefront subfield, and the luminous pulses are simply stacked to express a graduation level.

Assume that brightness of a phosphor is expressed by eight gradation levels of 0 to 7. In the random light emission method, one field includes three subfields, and the first subfield has a brightness weight of 1, the second subfield has a brightness weight of 2, and the third subfield has a brightness weight of 4.

A luminous pulse is generated in the first subfield to express gradation level 1, a luminous pulse is generated in the second subfield to express gradation level 2, a luminous pulse is generated in the first and second subfields to express gradation level 3, and gradation level 4 is expressed by generating a luminous pulse in the third subfield that has the largest affect on an afterglow in a next field.

In the frontward light emission method, one field includes seven subfields, and a luminous pulse is generated in the first subfield in the field to express gradation level 1, a luminous pulse is generated in the first and second subfields in the field to express gradation level 2, a luminous pulse is generated in the first to third subfields in the field to express gradation level 3, and a luminous pulse is generated in the first to fourth subfields in the field to express gradation level 4. Accordingly, as the gradation level increases, luminous pulses are generated in subfields towards the back of the field.

To express the gradation level 4 by the random light emission method, a luminous pulse is generated in the third subfield that has the largest affect on an afterglow in a next field. To express the gradation level 4 in the frontward light emission method, a luminous pulse is generated only in the first to fourth subfields among the seven subfields. Therefore, an afterglow caused by the luminous pulse in the fourth subfield attenuates in the fifth to seventh subfields, so that the affect on the next field is smaller than the random light emission method.

In other words, an amount of afterglow that affects the next field varies according to the light emission method employed, even at the same gradation level. Thus, if the conventional technology disclosed in Japanese Patent Application Laid Open No. 2004-138940, which is applied to the random light emission method, is applied to the frontward light emission method, an afterglow cannot be eliminated. Moreover, even when there is no afterglow, the incongruity increases.

Thus, there is a need of a technology capable of suppressing deterioration of the image quality due to the occurrence of the afterglow.

### SUMMARY OF THE INVENTION

It is an object of the present invention to at least solve the problems in the conventional technology.

According to an aspect of the present invention, an apparatus for processing video signals to control a display device that displays a video by emitting light from a plurality of phosphors corresponding to different colors based on output-display video signals generated by the apparatus, wherein the phosphors emit light in units of sequential fields, includes a processing unit that receives video signals and generates a display video signal for each of the colors from received video signals; a delaying unit that generates a delayed display video signal for each display video signal by delaying the display video signal by one field; a calculating unit that calculates an afterglow level of at least a first color among the colors based on the delayed display video signals; a correction-signal generating unit that generates a correction signal based on the afterglow level; a selecting unit that selects, as an output-display video signal for the first color, the display video signal of the first color when a level of the display video signal of the first color is equal to or higher than the correction signal, and selects the correction signal when a level of the display video signal of the first color is lower than the correction signal; and an output unit that outputs, to the display device, the display video signals for each color other than the first color as output-display video signals for each color other than the first color, and outputs selected output-display video signal for the first color.

According to another aspect of the present invention, a video display system includes the above apparatus for processing video signals and the display device. The display device includes a displaying unit including a plurality of cells, each cell including a combination of the phosphors corresponding to different colors, and a luminous-pulse generating unit that generates luminous pulses, which cause the phosphors to emit light, starting from a forefront of a field, wherein a number of the luminous pulses corresponds to an arbitrary number according to values of the output-display video signals for each color.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining light emission characteristics of phosphors of R, G, B;

FIG. 2 is a schematic of a video display system according to a first embodiment of the present invention;

FIG. 3 is a detailed block diagram of a media receiver shown in FIG. 2;

FIG. 4 is a detailed block diagram of an afterglow color-correcting unit shown in FIG. 3;

FIG. 5 is a detailed block diagram of a display device shown in FIG. 2;

FIG. 6 is a schematic for explaining a relationship between an afterglow level and a correction signal;

FIG. 7 is a waveform diagram of luminous pulses for R, G, B generated based on display video signals of R, G, B, and a correction display video signal of B; and

FIG. 8 is a diagram of an afterglow color-correcting unit of a media receiver according to a second embodiment of the present invention.

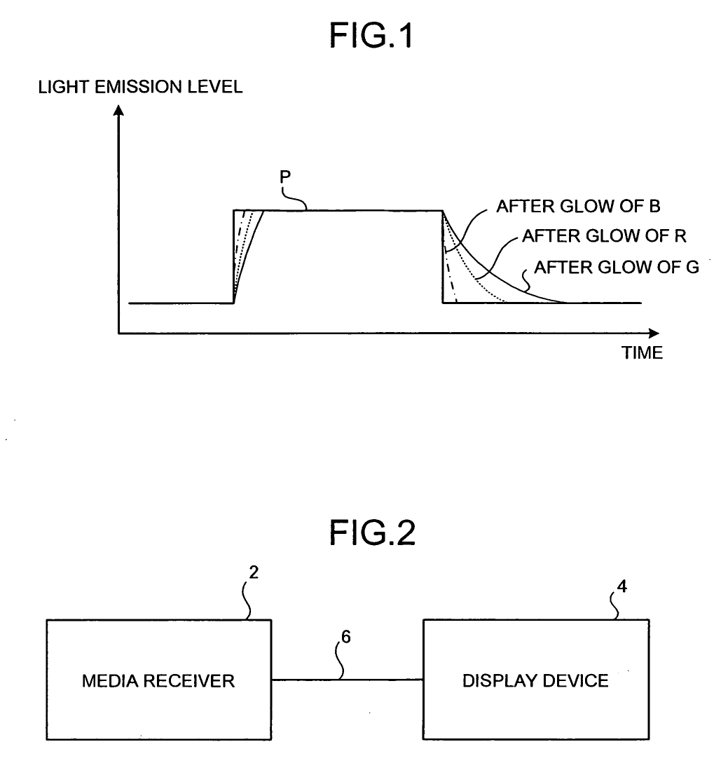

### DETAILED DESCRIPTION OF THE PREFERRED EMBODIMENTS

Exemplary embodiments of the present invention will be described below with reference to accompanying drawings. The present invention is not limited to these embodiments.

A video-signal processing apparatus according to an embodiment of the present invention calculates, from display video signals of each color of a previous field, an afterglow level for correcting a color subject to correction (hereinafter, correction subject color). The display video signals are generated from video signals, and indicate brightness of each color. The afterglow level is used for performing afterglow correction processing on a display video signal of the first color. The video-signal processing apparatus generates a correction signal corresponding to the calculated afterglow level. When the level of the correction signal generated is higher than a display video signal of the first color in a current field, the correction signal is employed as an output display video signal of the first color. When the level of the correction signal generated is equal to or lower than the display video signal of the first color in the current field, the display video signal of the first color in the current field is employed as the output display video signal of the first color.

A first embodiment according to the present invention is described with reference to FIGS. 2 to 7. FIG. 2 is a video display system according to the first embodiment. The video display system includes a media receiver 2, a display device 4, and a transmission path 6 for connecting the media receiver 2 and the display device 4. The transmission path 6 is, for example, a cable.

The media receiver 2 receives a video signal from an external device. The external device can be, but not limited to, a digital versatile disk (DVD) player, a personal computer, a broadcast satellite (BS) digital broadcasting receiver. The media receiver 2 generates display video signals indicating brightness of R, G, B, which display brightness in gradation levels, from the received video signal. When generating display video signals of R, G, B, the media receiver 2 performs an afterglow color-correction processing for a video signal with the shortest afterglow (in this case, B) among R, G, B.

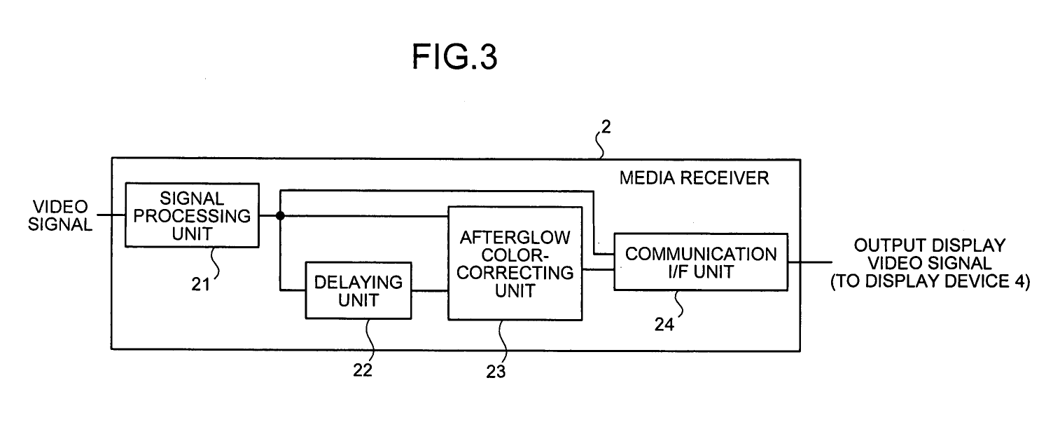

FIG. 3 is a detailed block diagram of the media receiver 2. The media receiver 2 includes a signal processing unit 21, a delaying unit 22, an afterglow color-correcting unit 23, and a communication interface (I/F) unit 24.

The signal processing unit 21 performs an interlace progressive (IP) conversion processing and a resize processing on video signals to generate video signals applicable to the display device 4, and generates display video signals of R, G, B from the generated video signals.

The delaying unit 22 generates delayed display video signals of R, G, B by delaying the display video signals of R, G, B generated by the signal processing unit 21 by a time of one field. The afterglow color-correcting unit 23 performs an afterglow color-correction processing on a display video signal of B based on the delayed display video signals of R, G, B generated by the delaying unit 22.

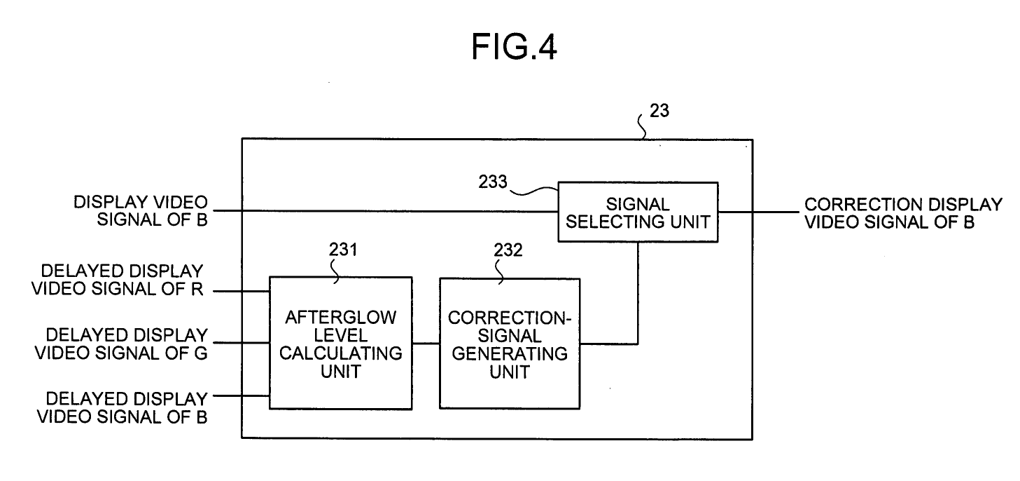

FIG. 4 is a detailed block diagram of the afterglow color-correcting unit 23. The afterglow color-correcting unit 23 includes an afterglow level calculating unit 231, a correction-signal generating unit 232, and a signal selecting unit 233.

The afterglow level calculating unit 231 calculates an afterglow level of display video signals of R, G, B in a previous field from delayed display video signals of R, G, B generated by the delaying unit 22. The correction-signal generating unit 232 generates a correction signal of B based on the afterglow level calculated by the afterglow level calculating unit 231. The signal selecting unit 233 corrects a display video signal of B based on the correction signal, and generates a correction display video signal of B.

Referring back to FIG. 3, the communication I/F unit 24 includes an interface function for communicating with the display device 4 and sending video information (field synchronization signals and output display video signals of R, G, B), which is used for displaying a video with video signals, to the display device 4, via the transmission path 6.

Referring back to FIG. 2, the display device 4 displays a video based on display video signals of R, G generated by the media receiver 2 and a correction display video signal of B.

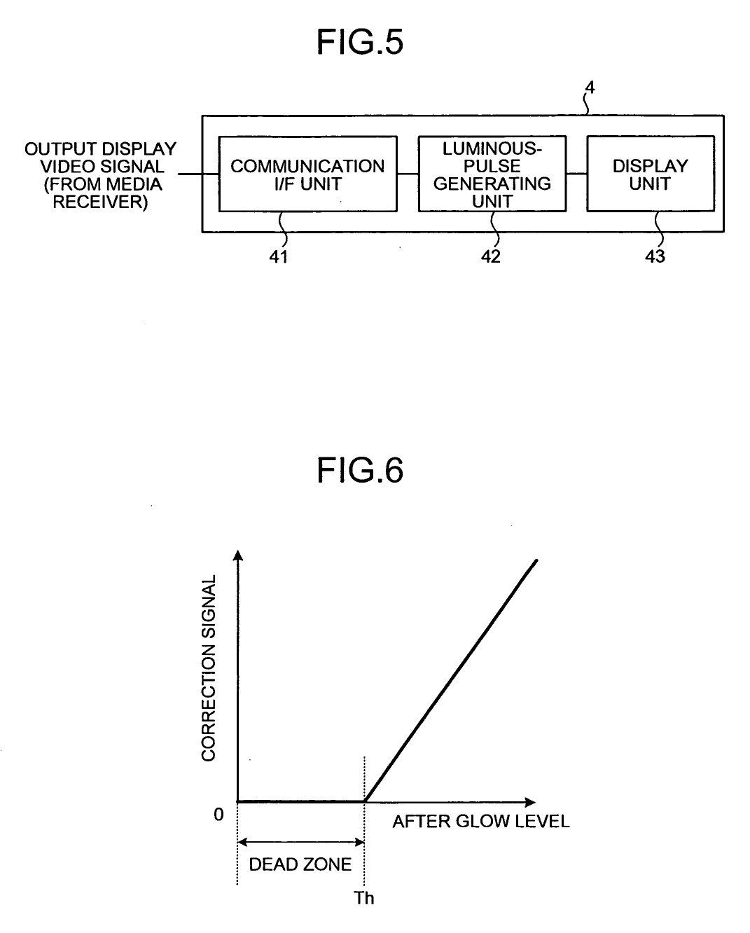

FIG. 5 is a detailed block diagram of the display device 4. The display device 4 includes a communication I/F unit 41, a luminous-pulse generating unit 42, and a display unit 43. The communication I/F unit 41 includes an interface function for communicating with the media receiver 2 and receiving video information from the media receiver 2, via the transmission path 6.

The luminous-pulse generating unit 42 generates a luminous pulse to be applied to the display unit 43, based on video information. Specifically, the luminous-pulse generating unit 42 generates luminous pulses that make phosphors of R, G, B in each cell emit light according to brightness of a gradation level indicated by output display video signals of R, G, B. The display device 4 employs a light emission control method by which an arbitrary number of luminous pulses are sequentially generated starting from the forefront of a field according to the levels of output display video signals of R, G, B. An example of such method is the frontward light emission method.

The display unit 43 is a PDP, and displays colors with a plurality of cells (combination of phosphors of R, G, B, corresponding to one pixel) driven by luminous pulses of R, G, B generated by the luminous-pulse generating unit 42.

The video display system according to the first embodiment operates in the manner explained below. The signal processing unit 21 performs an IP conversion processing and a resize processing to generate video signals applicable to the display unit 43. The signal processing unit 21 generates display video signals of R, G, B from the generated video signals. Specifically, the signal processing unit 21 selects a gradation level indicating brightness of phosphors of R, G, B in a cell corresponding to each pixel in the display unit 43, and the selected gradation level becomes display video signals of R, G, B. The signal processing unit 21 outputs the generated display video signals of R, G to the delaying unit 22, the afterglow level calculating unit 231, and the communication I/F unit 24, and outputs the display video signal of B to the delaying unit 22, the afterglow level calculating unit 231, and the signal selecting unit 233.

The delaying unit 22 generates delayed display video signals of R, G, B by delaying display video signals of R, G, B by a time of one field. The delaying unit 22 outputs the generated delayed display video signals of R, G, B to the afterglow level calculating unit 231.

The afterglow level calculating unit 231 calculates an afterglow level of display video signals of R, G, B in a previous field from delayed display video signals of R, G, B. Assuming that a delayed display video signal of a correction subject color, which is a subject of afterglow color-correction processing, is KD, and delayed display video signals of two non-correction subject colors other than the first color are FD1, FD2, an afterglow level Z for the first color is expressed by following equality:
Z=MIN(MAX(FD1,FD2),KD) (1)

In other words, the afterglow level calculating unit 231 selects a non-correction subject color other than the first color that has a higher delayed display video signal level. Subsequently, the afterglow level calculating unit 231 compares the delayed display video signal level of the selected non-correction subject color and that of the first color, and the one with a lower delayed display video signal level becomes the afterglow level.

Here, the first color is B, and therefore, it is assumed that the delayed display video signal of R is DR, the delayed display video signal of G is DG, the delayed display video signal of B is DB, and an afterglow level ZB of B is obtained from equality 1 as below:
ZB=MIN(MAX(DR,DG),DB) (2)
The afterglow level calculating unit 231 uses equality 2 to calculate the afterglow level ZB and outputs the calculated afterglow level ZB to the correction-signal generating unit 232.

The correction-signal generating unit 232 generates a correction signal based on the afterglow level ZB. Specifically, when the afterglow level ZB is in a dead zone, i.e., a level that does not require correction, the correction-signal generating unit 232 sets the correction signal at a predetermined fixed value. When the afterglow level ZB is outside the dead zone, the correction-signal generating unit 232 generates a correction signal corresponding to the afterglow level ZB.

Specifically, the correction-signal generating unit 232 compares the afterglow level ZB with a predetermined threshold ThB, determines whether the afterglow level ZB is within a dead zone, and generates a correction signal based on the determination result.

FIG. 6 is a schematic for explaining a relationship between an afterglow level and a correction signal. A horizontal axis represents an afterglow level, and a vertical axis represents a correction signal. When the afterglow level is equal to or less than a threshold Th, the correction signal is set at a fixed value, which is, in this case, 0. As the afterglow level exceeds the threshold Th, the level of the correction signal increases at a constant ratio with the increase of the afterglow level.

In other words, when the afterglow level is low, the correction-signal generating unit 232 determines that the afterglow level is sufficiently low so as not to affect the displayed view, and sets the correction signal at 0. When the afterglow level is high, the correction-signal generating unit 232 determines that the afterglow level sufficiently higher enough to affect the view, i.e., a tail of a comet might be created, and increases the level of the correction signal. For example, when the afterglow level is higher than the upper boundary of the dead zone, the correction-signal generating unit 232 can increase the level of the correction signal by a constant rate. However, any other criterion can be employed.

The correction-signal generating unit 232 outputs a generated correction signal to the signal selecting unit 233. The signal selecting unit 233 corrects the display video signal of B based on the correction signal. Specifically, the signal selecting unit 233 compares the display video signal of B and the correction signal, and determines whether to make a correction. When the level of the display video signal of B is equal to or higher than the level of the correction signal, the signal selecting unit 233 determines that it is not necessary to correct the display video signal of B, and outputs the display video signal of B as the correction display video signal of B to the communication interface unit 24.

When the level of the display video signal of B is lower than the level of the correction signal, the signal selecting unit 233 determines that it is necessary to correct the display video signal of B, and outputs the correction signal of B as the correction display video signal of B to the communication interface unit 24. In other words, the correction signal of B is obtained by adding an afterglow correction component to the display video signal of B.

The communication I/F unit 24 outputs, via the transmission path 6, video information including output display video signals of R, G, B to the display device 4. In this case, the afterglow color correction processing is not performed for R, G, and therefore, the display video signals for R, G become the output display video signals of R, G, and the correction display video signal of B becomes the output display video signal of B.

The display device 4 operates in the following manner. The communication I/F unit 41 receives, via the transmission path 6, video information from the media receiver 2, and outputs the video information to the luminous-pulse generating unit 42. The luminous-pulse generating unit 42 generates luminous pulses to be applied to the display unit 43 based on output display video signals of R, G, B in the video information. Specifically, the luminous-pulse generating unit 42 generates luminous pulses that make phosphors of R, G, B in each cell emit light corresponding to values, i.e., gradation levels, indicated by the output display video signals of R, G, B, and the generated luminous pulses for R, G, B are output to the display unit 43. The display unit 43 displays colors with a plurality of cells driven by the luminous pulses for R, G, B.

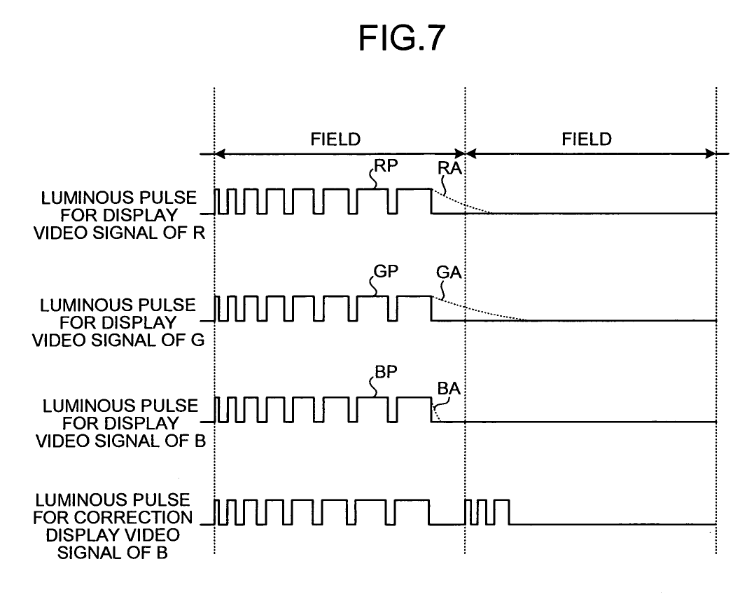

FIG. 7 is a waveform diagram of luminous pulses for R, G, B generated based on display video signals of R, G, B, and a correction display video signal of B. A first field displays white, and a second field displays black. To display white, the display video signals of R, G, B indicate values of maximum brightness, and therefore, in the first field, luminous pulses are generated in each subfield for the display video signals of R, G, B. The display video signal of B indicates a gradation level of maximum brightness, and therefore, the display video signal of B is selected as the correction display video signal of B.

To display black, the display video signals of R, G, B indicate values of minimum brightness, and therefore, in the second field, the display video signals of R, G, B are 0, and no luminous pulses are generated for the display video signals of R, G, B.

Luminous pulses RP, GP, BP generated in the last subfield in the first field create afterglows RA, GA, BA, respectively. The afterglows RA, GA remain in the second field. Thus, if the display video signal of B is employed, a green tail is created.

However, a correction display video signal of B is generated in the second field by correcting the display video signal of B based on an afterglow level of the display video signals of R, G, B in the first field, and a luminous pulse is generated so that a phosphor of B emits light. The light emitted by the phosphor of B and the afterglows RA, GB extend a display time of white of the first field, and prevents a tail from being created.

Thus, in the first embodiment, among the phosphors of R, G, B used in the display unit 43 of the display device 4, the phosphor of B, emits the shortest afterglow, is subject to color correction. The signal processing unit 21 generates display video signals R, G, B from video signals, and the delaying unit 22 generates delayed display video signals of R, G, B by delaying the display video signals of R, G, B by a time of one field. The afterglow level calculating unit 231 calculates an afterglow level of display video signals of R, G, B in a previous field, from the delayed display video signals of R, G, B. The correction-signal generating unit 232 generates a correction signal of B based on the afterglow level. When the level of the correction signal of B is higher than the level of the display video signal of B, the signal selecting unit 233 selects the correction signal of B as the correction display video signal of B. When the level of the correction signal of B is equal to or lower than the level of the display video signal of B, the signal selecting unit 233 selects the display video signal of B as the correction display video signal of B. The display video signals of R, G are sent as the output display video signals of R, G, and the correction display video signal of B is sent as the output display video signal of B, to the display device 4.

Thus, a decrease in video display quality caused by an afterglow of a previous field is suppressed, so that a video without congruity is displayed to a viewer.

Moreover, when an afterglow level is equal to or lower than a predetermined threshold, the correction-signal generating unit 232 sets a correction signal at a predetermined fixed level. When an afterglow level is higher than the threshold, the correction-signal generating unit 232 generates a correction signal corresponding to the afterglow level. Accordingly, compared to a case of correcting a display video signal at a constant ratio, video display quality affected by an afterglow of a previous field can be improved.

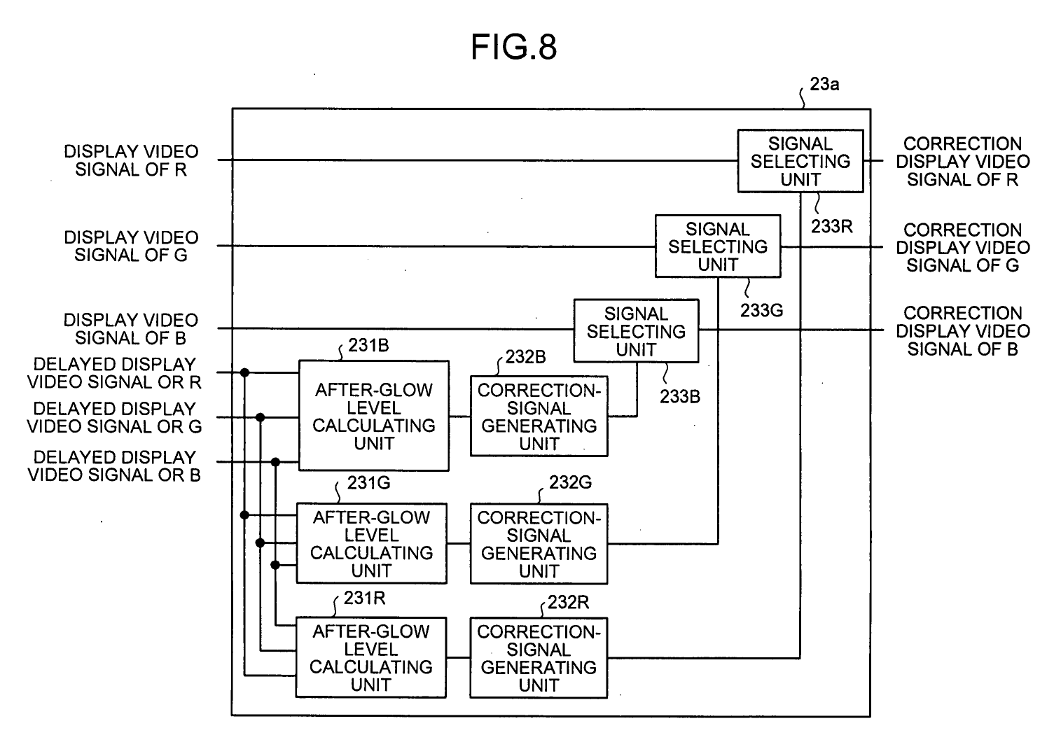

A second embodiment according to the present invention is described with reference to FIG. 8. In the first embodiment, the phosphor of B, which has the smallest afterglow amount among the phosphors of R, G, B, is the first color, and the display video signal of B is corrected based on afterglow levels in a previous field. However, all of the colors, R, G, B, can be correction subject colors, and display video signals of R, G, B can be corrected.

In the second embodiment, the media receiver 2 includes an afterglow color-correcting unit 23a that performs an afterglow color-correction processing for display video signals of R, G, B, instead of the afterglow color-correcting unit 23 of the first embodiment shown in FIG. 4. The signal processing unit 21 outputs generated display video signals of R, G, B to the delaying unit 22 and the afterglow color-correcting unit 23a. The rest of the configuration of a video display system according to the second embodiment is substantially the same as that in the first embodiment.

The display video signals of R, G, B that have undergone the afterglow color-correction processing, i.e. correction display video signals of R, G, B, are sent to the display device 4 as output display video signals of R, G, B.

FIG. 8 is a detailed block diagram of the afterglow color-correcting unit 23a. The afterglow color-correcting unit 23a includes an afterglow level calculating unit 231R that calculates an afterglow level for correcting a display video signal of R, a correction-signal generating unit 232R that generates a correction signal of R based on the afterglow level calculated by the afterglow level calculating unit 231R, a signal selecting unit 233R that corrects the display video signal of R based on the correction signal generated by the correction-signal generating unit 232R, an afterglow level calculating unit 231G that calculates an afterglow level for correcting a display video signal of G, a correction-signal generating unit 232G that generates a correction signal of G based on the afterglow level calculated by the afterglow level calculating unit 231G, a signal selecting unit 233G that corrects the display video signal of G based on the correction signal generated by the correction-signal generating unit 232G, an afterglow level calculating unit 231B that calculates an afterglow level for correcting a display video signal of B, a correction-signal generating unit 232B that generates a correction signal of B based on the afterglow level calculated by the afterglow level calculating unit 231B, and a signal selecting unit 233B that corrects the display video signal of B based on the correction signal generated by the correction-signal generating unit 232B.

The video display system according to the second embodiment operates in the following manner. The only difference between the video display system according to the second embodiment and video display system according to the first embodiment is that the afterglow color-correction processing is performed for all the display video signals R, G, B in the second embodiment while the afterglow color-correction processing is performed only for the display video signal B in the first embodiment. Therefore, an operation performed by the afterglow color-correcting unit 23a is only described here to avoid duplication of explanation. Furthermore, operations performed by the afterglow level calculating unit 231B, the correction-signal generating unit 232B, and the signal selecting unit 233B are the same as the afterglow level calculating unit 231, the correction-signal generating unit 232, and the signal selecting unit 233, respectively, and therefore, overlapping descriptions are omitted.

An afterglow color-correction processing, in which R is a correction subject color, is performed in the manner explained below. The afterglow level calculating unit 231R calculates an afterglow level based on delayed display video signals of R. G, B input from the delaying unit 22.

Assuming that the delayed display video signal of R is DR, the delayed display video signal of G is DG, and the delayed display video signal of B is DB, an afterglow level ZR of R is obtained from equality 1 as below:
ZR=MIN(MAX(DB,DG),DR) (3)
The afterglow level calculating unit 231R calculates the afterglow level ZR using equality 3, and outputs the result to the correction-signal generating unit 232R.

The correction-signal generating unit 232R generates a correction signal based on the afterglow level ZR. Specifically, the correction-signal generating unit 232R compares the afterglow level ZR with a predetermined threshold ThR, and determines whether the afterglow level ZR is within a dead zone. When the afterglow level ZR is equal to or lower than the threshold ThR, the correction-signal generating unit 232R outputs a correction signal of R of a predetermined level to the signal selecting unit 233R. When the afterglow level ZR is higher than the threshold ThR, the correction-signal generating unit 232R generates a correction signal corresponding to the afterglow level ZR, and outputs the correction signal to the signal selecting unit 233R.

The signal selecting unit 233R compares the display video signal of R and the correction signal, and determines whether to make a correction. When the level of the display video signal of R is equal to or higher than the level of the correction signal, the signal selecting unit 233R determines that it is not necessary to correct the display video signal of R, and outputs the display video signal of R as the correction display video signal of R to the communication interface unit 24.

When the level of the display video signal of R is lower than the level of the correction signal, the signal selecting unit 233R outputs the correction signal of R as the correction display video signal of R to the communication interface unit 24. In other words, the correction signal of R is obtained by adding an afterglow correction component to the display video signal of R.

An afterglow color-correction processing for a display video signal of G, in which G is a correction subject color, is performed is performed in the manner explained below. The afterglow level calculating unit 231G calculates, for G as the first color, an afterglow level based on delayed display video signals of R, G, B input from the delaying unit 22.

Assuming that the delayed display video signal of G is DG, the delayed display video signal of G is DG, and the delayed display video signal of B is DB, an afterglow level ZG of G is obtained from equality 1 as below:
ZG=MIN(MAX(DB,DR),DG) (4)
The afterglow level calculating unit 231G calculates the afterglow level ZG using equality 4, and outputs the result to the correction-signal generating unit 232G.

The correction-signal generating unit 232G generates a correction signal based on the afterglow level ZG. Specifically, the correction-signal generating unit 232G compares the afterglow level ZG with a predetermined threshold ThG, and determines whether the afterglow level ZG is within a dead zone. When the afterglow level ZG is equal to or lower than the threshold ThG, the correction-signal generating unit 232G outputs a correction signal of G of a predetermined level to the signal selecting unit 233G. When the afterglow level ZG is higher than the threshold ThG, the correction-signal generating unit 232G generates a correction signal corresponding to the afterglow level ZG, and outputs the correction signal to the signal selecting unit 233G.

The signal selecting unit 233G compares the display video signal of G and the correction signal, and determines whether to make a correction. When the level of the display video signal of G is equal to or higher than the level of the correction signal, the signal selecting unit 233G outputs the display video signal of G as the correction display video signal of G to the communication interface unit 24.

When the level of the display video signal of G is lower than the level of the correction signal, the signal selecting unit 233G outputs the correction signal of G as the correction display video signal of G to the communication interface unit 24. In other words, the correction signal of G is obtained by adding an afterglow correction component to the display video signal of G.

Thus, in the second embodiment, the phosphors of all colors in the display unit 43 of the display device 4 are subject to color correction. For each correction subject color, correction signals are generated based on an afterglow level calculated from display video signals of R, G, B in a previous field. When the level of a generated correction signal is higher than the level of a display video signal in a current field, the correction signal, which is obtained by adding an afterglow correction component to the display video signal in the current field, is output to the display device 4 as an output display video signal. When the level of the correction signal is equal to or lower than the level of a display video signal in a current field, the display video signal in the current field is output as the output display video signal. Thus, a decrease in video display quality caused by an afterglow of a previous field is suppressed, so that a video without congruity is displayed to a viewer.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for processing video signals to control a display device that displays a video by emitting light from a plurality of phosphors corresponding to different colors based on output-display video signals generated by the apparatus, wherein the phosphors emit light in units of sequential fields, the apparatus comprising:
a processing unit that receives video signals and generates a display video signal for each of the colors from received video signals;
a delaying unit that generates a delayed display video signal for each display video signal by delaying the display video signal by one field;
a calculating unit that calculates an afterglow level of at least a first color among the colors based on the delayed display video signals;
a correction-signal generating unit that generates a correction signal based on the afterglow level;
a selecting unit that selects, as an output-display video signal for the first color, the display video signal of the first color when a level of the display video signal of the first color is equal to or higher than the correction signal, and selects the correction signal when a level of the display video signal of the first color is lower than the correction signal; and
an output unit that outputs, to the display device, the display video signals for each color other than the first color as output-display video signals for each color other than the first color, and outputs selected output-display video signal for the first color.

2. The apparatus according to claim 1, wherein the calculating unit
selects a delayed display video signal having a highest level among delayed display video signals for colors other than the first color, and
sets, as the afterglow level, a level of a signal that is lower among the level of selected delayed display video signal and a level of the delayed display video signal of the first color.

3. The apparatus according to claim 1, wherein the correction-signal generating unit
sets a level of the correction signal at a predetermined level when the afterglow level is equal to or lower than a predetermined threshold for the first color, and
changes the level of the correction signal according to the afterglow level when the afterglow level exceeds the threshold.

4. The apparatus according to claim 1, wherein
the first color includes a plurality of second colors, and
one of the second colors corresponds to a phosphor that emits an afterglow for shortest time among the phosphors.

5. A video display system comprising:
an apparatus for processing video signals to control a display device that displays a video by emitting light from a plurality of phosphors corresponding to different colors based on output-display video signals generated by the apparatus, wherein the phosphors emit light in units of sequential fields, the apparatus including
a processing unit that receives video signals and generates a display video signal for each of the colors from received video signals;
a delaying unit that generates a delayed display video signal for each display video signal by delaying the display video signal by one field;
a calculating unit that calculates an afterglow level of at least a first color among the colors based on the delayed display video signals;
a correction-signal generating unit that generates a correction signal based on the afterglow level;
a selecting unit that selects, as an output-display video signal for the first color, the display video signal of the first color when a level of the display video signal of the first color is equal to or higher than the correction signal, and selects the correction signal when a level of the display video signal of the first color is lower than the correction signal; and
an output unit that outputs, to the display device, the display video signals for each color other than the first color as output-display video signals for each color other than the first color, and outputs selected output-display video signal for the first color, wherein
the display device includes
a displaying unit including a plurality of cells, each cell including a combination of the phosphors corresponding to different colors, and
a luminous-pulse generating unit that generates luminous pulses, which cause the phosphors to emit light, starting from a forefront of a field, wherein a number of the luminous pulses corresponds to an arbitrary number according to values of the output-display video signals for each color.
